(19) United States
(12) Patent Application Publication
(10) Pub. No.: US 2009/0089003 A1
(43) Pub. Date: Apr. 2, 2009

(54) Accessory-testing device and method therefor

(75) Inventors: Xue-Shan Han, Tianjin (CN); Quan-Jie Zheng, Tianjin (CN); Jeff Song, Taipei (TW); Jhih-Ren Jin, Taipei (TW); Tom Chen, Taipei (TW); Win-Harn Liu, Taipei (TW)

Correspondence Address: Muncy, Geissler, Olds & Lowe, PLLC, P.O. BOX 1364, FAIRFAX, VA, 22038-1364, US

(73) Assignee: INVENTEC CORPORATION

(21) Appl. No.: 11/905,339

(22) Filed: Sep. 28, 2007

(51) Int. Cl. G06F 19/00

(52) U.S. Cl. 702/117

(57) ABSTRACT

An accessory-testing device for an information processing apparatus includes a micro-processing unit (MPU) and a signal conversion unit. The MPU sends a mimic signal. The signal conversion unit is electrically connected to the MPU and an accessory respectively, for receiving the mimic signal and converting the mimic signal into a test signal to test the accessory. The accessory receives the test signal and then responds to the test signal to output a feedback signal. The feedback signal is received by the signal conversion unit and transmitted to the MPU, such that the MPU determines if the accessory operates normally according to the feedback signal. Conventional testing methods are Therefore, it is achieved that the effects of reducing the inspection time and improving the production efficiency.

### BACKGROUND OF THE INVENTION

1. Field of Invention

The present invention relates to an accessory-testing device for an information processing apparatus, and more particularly to an accessory-testing device and method therefor that utilizes a mimic signal that mimics a signal for simulating an operation of a component in an information processing apparatus to test an accessory.

2. Related Art

The earliest information processing apparatus mainly uses vacuum tubes, and has limited functions due to the large volume and poor heat dissipation effect. In order to eliminate those deficiencies, transistors are put forward to reduce the volume of the information processing apparatus system. After the integrated circuit (IC) has been developed, many transistors may be arranged on a thumbnail area. Later, in the times of microprocessors, the number of the transistors on a unit area in an IC is increased to several hundred thousand or above, so the volume of the information processing apparatus is much smaller and less power is consumed. On appearance, for desktop, laptop, and palmtop computers, both the improvements in functions and the features of portability indicates that the information processing apparatuses are developed in the trend of “light, thin, short, small” and portability in future.

In mass production of the accessories, hardware manufacturers usually inspect the accessories by means of sampling inspection. However, during the inspection, an accessory must be assembled with a host device of the information processing apparatus, and then the apparatus is powered on to run the inspection program, and after that, the apparatus is powered off to replace the accessory. This inspection manner requires the assembly of the complete apparatus and the installation of a software system, thus consuming much time. Moreover, frequent plugging/unplugging of the accessories may damage the host device. Some accessories need the monitoring of external errors, so the inspection of the complete apparatus cannot be simulated. Further, the inspection environment needs a large working space.

Therefore, researchers try hard to find a new testing method to replace the conventional testing methods, so as to reduce the inspection time, reduce the operating space, and improve the production efficiency.

### SUMMARY OF THE INVENTION

In view of the above problems, the present invention provides an accessory-testing device for an information processing apparatus to reduce the inspection time, reduce the operating space, and improve the production efficiency.

An accessory-testing device according to the present invention includes a MPU (micro-processing unit) and a signal conversion unit. The MPU is used to send a mimic signal that mimics a signal simulating an operation of a component in the information processing apparatus. The signal conversion unit is electrically connected to the MPU and an accessory respectively. The signal conversion unit receives the mimic signal and converts the mimic signal into a test signal to test the accessory. The accessory receives the test signal and then outputs a feedback signal in response to the test signal. The feedback signal is received by the signal conversion unit and is then transmitted to the MPU, such that the MPU determines whether the accessory operates normally according to the feedback signal or not.

The accessory-testing device uses an MPU to send the mimic signal that mimic a signal simulating an operation of a component in the information processing apparatus, and a signal conversion unit to convert the mimic signal into a test signal to test the accessory. The accessory receives the test signal and then outputs a feedback signal in response to the test signal. The feedback signal is received by the signal conversion unit and then transmitted to the MPU, such that the MPU determines whether the accessory operates normally according to the feedback signal. The deficiencies of the conventional testing methods are eliminated from the above test process, and the inspection time of the accessory under test is reduced, thus improving the production efficiency.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an accessory-testing device according to the present invention;

FIG. 2 is another schematic view of an accessory-testing device according to the present invention; and

FIG. 3 is a flow chart of an accessory-testing method of the present invention.

### DETAILED DESCRIPTION OF THE INVENTION

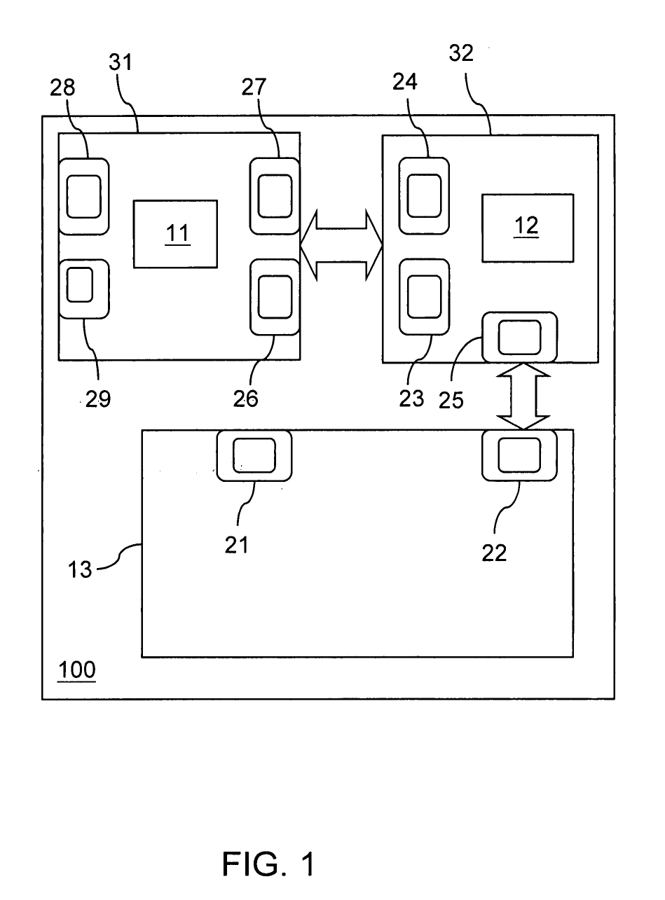

FIG. 1 is a schematic view of an accessory-testing device according to the present invention. Referring to FIG. 1, the accessory-testing device 100 includes an MPU 11, a signal conversion unit 12, an accessory 13, a first circuit board 31, and a second circuit board 32.

The accessory 13 has, but not limited to, an inter integrated circuit (I2C) signal transmission interface 21 and a general purpose input/output (GPIO) signal transmission interface 22, or other connection interfaces. The accessory 13 receives the test signal and then outputs a feedback signal in response to the test signal. The accessory 13 may be an LED board, a fan board, or an SAS BP board. The LED board is used to indicate the state of the host device, the result of the temperature inspection, and the ON/OFF state of the key. The SAS BP board is connected to an SAS hard drive and controls the working state indicator of the hard drive. The fan board is used to control and inspect the operation of the fan and to monitor the temperature of the mainboard.

The signal conversion unit 12 is disposed on the second circuit board 32. The second circuit board 32 has, but not limited to, an I2C interface 23, a GPIO interface 24, and/or a GPIO interface 25, or other connection interfaces. The second circuit board 32 is electrically connected to the first circuit board 31 and the accessory 13 through the aforementioned I2C interface 23, GPIO interface 24, and/or GPIO interface 25.

The signal conversion unit 12 receives the mimic signal and converts the mimic signal into a test signal to test the accessory 13. Then, the signal conversion unit 12 receives a feedback signal sent by the accessory 13 and sends the feedback signal back to the MPU, such that the MPU determines whether the accessory operates normally according to the feedback signal.

The MPU 11 is disposed on the first circuit board 31. The first circuit board 31 may have, but not limited to, an I2C interface 26 and/or a GPIO interface 27, or other connection interfaces. The first circuit board 31 is electrically connected to the second circuit board 32 through the aforementioned I2C interface 26 and/or GPIO interface 27. The first circuit board 31 may have, but not limited to, a parallel port 28 and/or a network connection port 29, or other connection ports.

The MPU 11, in response to an external enable signal, sends the mimic signal that mimics one for simulating the operation of a component in the information processing apparatus to the signal conversion unit 12 through the parallel port 28 and/or the network connection port 29, and receives a feedback signal of the accessory 13 sent back by the signal conversion unit 12. The MPU 11 determines whether the accessory 13 operates normally according to the feedback signal, and transmits the test result to an external device through the parallel port 28 and/or the network connection port 29.

The MPU 11 responds to an external enable signal through the parallel port 28 and/or the network connection port 29. For example, the test instruction “0001” represents SAS signal test, “0010” represents video graphic array (VGA) power signal test, “0011” represents universal serial bus (USB) power signal test, “0100” represents USB signal test, and “0110” represents green-LED test in the system (SYS). The above descriptions of test instructions and the instruction contents are only used as an example, and do not intend to limit the present invention. The MPU 11 receives an external enable test instruction and sends the mimic signal that simulates the operation of a component in the information processing apparatus, and then transmits the mimic signal to the signal conversion unit 12 via the I2C interface 26 and/or the GPIO interface 27. The signal conversion unit 12 converts the received mimic signal into a test signal to test the accessory 13. After the accessory 13 receives the test signal to be tested according the test signal. For example, it is assumed the accessory is the LED, it is determined whether the LED indicates to the information representing the temperature higher than normal in response to the test signal representing the temperature higher than normal or not, or whether the LED indicates the on state of the key in response to the test signal representing that the key is pressed. Then, the feedback signal is transmitted to the MPU 11 through the signal conversion unit 12. The MPU 11 determines whether the accessory 13 operates normally according to the feedback signal. In another embodiment, the MPU 11 transmits the test result to an external device (not shown) through the parallel port 28 and/or the network connection port 29.

As the connection interface of each accessory 13 under test is varied, the connection interface of the second circuit board 32 may be different. Therefore, the compatibility can be achieved by merely changing the second circuit board 32 and the test functions of the software and firmware.

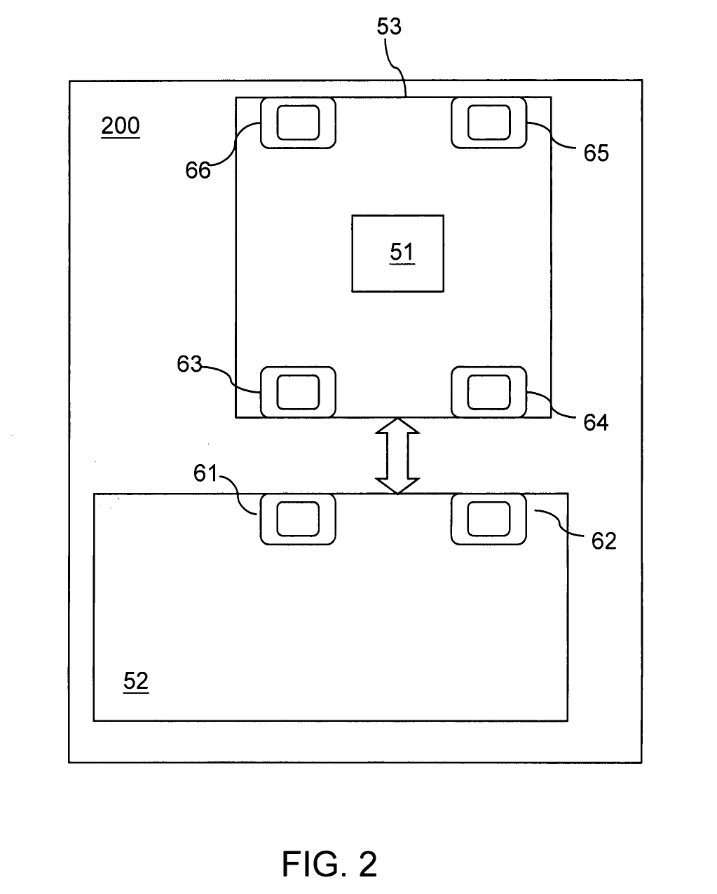

FIG. 2 is another schematic view of an accessory-testing device according to the present invention. Referring to FIG. 2, the accessory-testing device 200 includes an MPU 51, an accessory 52, and a first circuit board 53.

The accessory 52 may have, but not limited to, an I2C interface 61 and a GPIO interface 62, or other connection interfaces. The accessory 52 receives the test signal and then outputs a feedback signal in response to the test signal. The accessory 52 may be an LED board, a fan board, or an SAS BP board. The LED board is used to indicate the state of the host device, the result of the temperature inspection, and the ON/OFF state of the key. The SAS BP board is connected to an SAS hard drive and controls the working state indicator of the hard drive. The fan board is used to control and inspect the operation of the fan and to monitor the temperature of the mainboard.

The MPU 51 is disposed on the first circuit board 53. The first circuit board 53 may have, but not limited to, an I2C interface 63 and/or a GPIO interface 64, or other connection interfaces. The first circuit board 53 is electrically connected to the accessory 52 through the aforementioned I2C interface 63 and/or GPIO interface 64. The first circuit board 53 may have, but not limited to, a parallel port 65 and/or a network connection port 66.

The MPU 51 responds to an external enable signal through the parallel port 65 and/or the network connection port 66. For example, the test instruction “0001” represents SAS signal test, “0010” represents VGA power signal test, “0011” represents USB power signal test, “0100” represents USB signal test, and “0110” represents green-LED test in the system. The above descriptions of test instructions and the instruction contents are only used as an example, and do not intend to limit the present invention. The MPU 51 receives an external enable test instruction and sends a mimic signal that simulates the operation of a component in the information processing apparatus, and then converts the mimic signal into a test signal, and receives a feedback signal sent by the accessory 52. The MPU 51 determines whether the accessory 52 operates normally according to the feedback signal, and transmits the test result to an external device through the parallel port 65 and/or the network connection port 66.

The MPU 51 sends the mimic signal that mimics a signal for simulating the operation of a component in the information processing apparatus, in response to an external enable signal through the parallel port 65 and/or the network connection port 66, and converts the mimic signal into a test signal. The test signal is transmitted to the accessory 52 through the I2C interface 63 and/or the GPIO interface 64 for testing the accessory 52. The accessory 52 receives the test signal to drive the LED of the accessory 52, receives the signal such as key press action, and sends a feedback signal back to the MPU 51. The MPU 51 determines whether the accessory 52 operates normally according to the feedback signal, and transmits the test result to an external device through the parallel port 65 and/or the network connection port 66.

As the connection interface of each accessory 52 under test is varied, the connection interface of the first circuit board 53 may be different. The compatibility can be achieved by merely changing the first circuit board 53 and the test functions of the software and firmware.

The difference between the first embodiment and the second embodiment of the present invention is described as follows. A second circuit board 32 is adopted in the first embodiment of the present invention to extend the connection. Meanwhile, an independent signal conversion unit 12 is employed to shoulder a part of the function of the MPU 51 in the second embodiment. That is, the signal conversion unit 12 converts the mimic signal that simulates the operation of a component in the information processing apparatus into a test signal instead, so the workload of the MPU 11 is alleviated, thus improving the test efficiency.

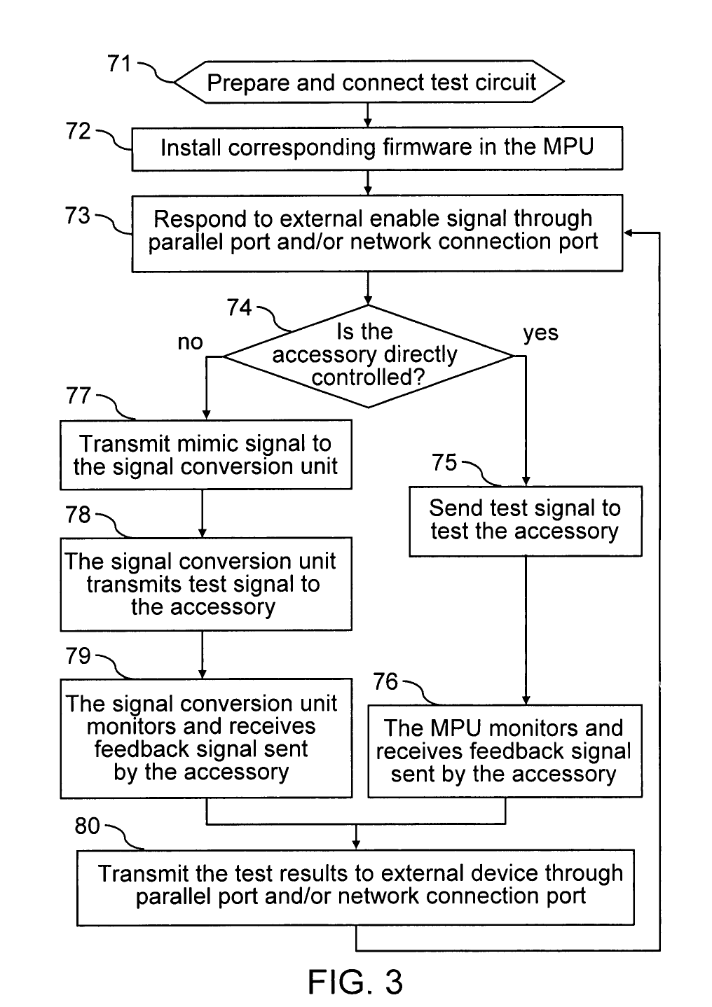

Referring to FIG. 3, a flow chart of an accessories testing method of the present invention is shown. First, a test circuit is prepared and connected (Step 71). A corresponding firmware is installed in the MPU (Step 72). Respond to an external enable signal through a parallel port and/or a network connection port (Step 73). The MPU receives the external enable signal and then determines whether the accessory is directly controlled (Step 74).

If the MPU directly controls the accessory under test, subsequent to Step 74, the MPU sends the mimic signal that simulates the operation of a component in the information processing apparatus, converts the mimic signal into a test signal, and transmits the test signal to test the accessory under test (Step 75). The MPU then monitors and receives a feedback signal sent by the accessory (Step 76).

If the MPU does not directly control the accessory under test, subsequent to Step 74, the MPU sends the mimic signal that simulates the operation of a component in the information processing apparatus, and transmits the mimic signal to the signal conversion unit (Step 77). The signal conversion unit receives the mimic signal, and converts the received mimic signal into a test signal to test the accessory under test (Step 78). Then, the signal conversion unit monitors and receives a feedback signal from the accessory (Step 79).

The MPU determines whether the accessory operates normally according to the test results of Step 76 and Step 79, and transmits the test results to an external device through a parallel port and/or a network connection port (Step 80). If another test is required, return to Step 73 to respond an external enable signal through a parallel port and/or a network connection port.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An accessory-testing device of an information processing apparatus, for testing an accessory, comprising:
a micro-processing unit (MPU), for sending a mimic signal, wherein the mimic signal mimics a signal for simulating an operation of a component in the information processing apparatus; and
a signal conversion unit, electrically connected to the MPU and the accessory respectively, for receiving the mimic signal and converting the mimic signal into a test signal to test the accessory, wherein the accessory receives the test signal and then reaponds to the test signal to output a feedback signal, and the feedback signal is received by the signal conversion unit and then transmitted to the MPU, such that the MPU determines if the accessory operates normally according to the feedback signal.

2. The accessory-testing device as claimed in claim 1, wherein the MPU sends the mimic signal in response to an external enable signal.

3. The accessory-testing device as claimed in claim 1, wherein the enable signal is transmitted to the MPU through a network connection port.

4. The accessory-testing device as claimed in claim 1, wherein the enable signal is transmitted to the MPU through a parallel port.

5. The accessory-testing device as claimed in claim 1, wherein the MPU is connected to the signal conversion unit through an inter integrated circuit (I2C) interface and/or a general purpose input/output (GPIO) interface.

6. The accessory-testing device as claimed in claim 1, wherein the signal conversion unit is connected to the accessory through an I2C interface and/or a GPIO interface.

7. An accessory-testing device for an information processing apparatus, for testing a accessory, comprising:
a micro-processing unit (MPU), for sending an mimic signal, wherein the mimic signal mimics a signal for simulating an operation of a component in the information processing apparatus, and converting the mimic signal into a test signal to test the accessory, wherein the accessory receives the test signal and then responds to the test signal to output a feedback signal, and the feedback signal is received by the signal conversion unit and then transmitted to the MPU, such that the MPU determines if the accessory operates normally according to the feedback signal.

8. The accessory-testing device as claimed in claim 7, wherein the MPU sends the mimic signal in response to an external enable signal.

9. The accessory-testing device as claimed in claim 7, wherein the enable signal is transmitted to the MPU through a network connection port.

10. The accessory-testing device as claimed in claim 7, wherein the enable signal is transmitted to the MPU through a parallel port.

11. The accessory-testing device as claimed in claim 7, wherein the MPU is connected to the accessory through an I2C interface and/or a GPIO interface.

12. An accessory-testing method for an information processing apparatus, for testing an accessory, comprising:
responding to an enable signal to determine if the accessory is directly controlled;
if the accessory is not directly controlled, sending an mimic signal by a micro-processing unit (MPU), wherein the mimic signal mimics a signal for simulating an operation of a component in the information processing apparatus;
receiving the mimic signal, and converting the mimic signal into a test signal to test the accessory; and
receiving the test signal and then responding to the test signal to output a feedback signal by the accessory, such that it is determined if the accessory operates normally according to the feedback signal.

13. The accessory-testing method as claimed in claim 12, wherein if the accessory is directly controlled, the MPU directly converts the mimic signal into the test signal to test the accessory.

14. The accessory-testing method as claimed in claim 13, wherein it is determined if the accessory operates normally according to the feedback signal by the MPU.
